(19) United States
(12) Patent Application Publication
(10) Pub. No.: US 2011/0150093 A1
(43) Pub. Date: Jun. 23, 2011

(54) METHODS AND APPARATUS FOR COMPLETION OF VIDEO STABILIZATION

(76) Inventors: Stephen Mangiat, Goleta, CA (US); Yi-Jen Chiu, San Jose, CA (US)

(21) Appl. No.: 12/644,825

(22) Filed: Dec. 22, 2009

(51) Int. Cl. H04N 11/02

(52) U.S. Cl. 375/240.16; 375/E07.001

(57) ABSTRACT

Systems and methods for video completion. A set of global motion parameters may be determined for a current frame that is to be stabilized. Motion vectors for edge blocks of the current frame may then be calculated. For a prospective new block beyond the current frame, candidate blocks may be generated using a global motion vector and the calculated motion vectors. From the candidate blocks, a candidate block may be selected to be the new block, wherein the selected candidate block may be located at least partially within the outer boundary of the eventual stabilized version of the current frame.

### BACKGROUND

The goal of video stabilization is to eliminate, in a video, the results of unintentional camera motion caused by a shaky platform. This global motion may include motion introduced by panning, rotating, or zooming the camera. Global motion estimation may be performed using a variety of methods, including intensity alignment, feature matching, and block motion vector filtering. The resultant motion parameters may be smoothed, typically using a Gaussian kernel, and frames may then be warped to compensate for high frequency jitter. However, frame warping introduces missing regions near the edge of the frame. If these regions are left visible, the video may still appear unstable. A common way to address this is to crop the frame. Depending on the amount of motion, this could lead to a significantly smaller frame size, which is undesirable.

Video completion may be used to achieve stabilized videos at their original resolution, a process referred to as “full-frame video stabilization.” Missing regions introduced by frame warping may be filled using information from past (or future) frames and/or image inpainting. A missing pixel can be filled using a neighboring frame if its motion vector is known, yet because these pixels lie outside the original frame their motion cannot be calculated. However, the global transformation used for warping may extend to this region outside of the frame, assuming that it lies on the same plane as the image. Therefore one baseline completion method is to mosaic neighboring frames onto the current warped image using global two dimensional transformations.

Mosaicking based on global motion parameters may cause neighboring frames to overlap. If there is more than one candidate for a given pixel, the median of these points may be used. The variance of the candidates determines the quality of the match—if the variance is low the mosaic frames may be somewhat consistent and the region likely has little texture. If the variance is high, using the median may produce a blurring effect. A second option may be to choose the point taken from the frame that is nearest to the current frame, with the assumption that nearer frames provide better overall matches. However this can lead to discontinuities at the frame boundaries. Furthermore, global parameters may only produce good results when there is no local motion in the missing region. Local motion may not be captured by a global transformation, and therefore cannot be handled by using global mosaicking.

To avoid discontinuities and blurring, local motion near the frame edge may be utilized during video completion. Towards this end, some solutions first use the global mosaicking method to fill in regions with low variance. For any remaining holes, they fill in local motion vectors for the missing regions using optical flow calculated at their boundaries, a process called “motion inpainting.” This method may produce visually acceptable results, but requires expensive optical flow computations. Similarly, other solutions pose video completion as a global optimization problem, filling in space-time patches that improve local and global coherence. This method may be robust and can fill missing regions, but also presents a large computational burden.

### BRIEF DESCRIPTION OF THE DRAWINGS/FIGURES

FIG. 1 is a flowchart illustrating overall processing, according to an embodiment.

FIG. 2 illustrates the use of a global motion vector, according to an embodiment.

FIG. 3 is a flowchart illustrating the determination of a motion vector for an edge block, according to an embodiment.

FIG. 4 illustrates motion vectors used in the generation of candidate blocks, according to an embodiment.

FIG. 5 is a flowchart illustrating the generation of candidate blocks, according to an embodiment.

FIG. 6 is a flowchart illustrating the selection of a candidate block, according to an embodiment.

FIG. 7 illustrates the relationship between a selected block and an outer boundary, according to an embodiment.

FIG. 8 illustrates a scanning order for completion of a video frame, according to an embodiment.

FIG. 9 is a block diagram showing modules that may implement the system, according to an embodiment.

FIG. 10 is a block diagram showing software or firmware modules that may implement the system, according to an embodiment.

### DETAILED DESCRIPTION

Video stabilization seeks to improve the visual quality of captured videos by removing or reducing unintentional motion introduced by a shaky camera. A main component of stabilization may be frame warping, which introduces missing regions near the edge of the frame. Commonly, these missing pixels may be removed by frame cropping, which can reduce video resolution substantially. This creates the need for video completion to fill in missing pixels at frame boundaries without cropping.

The following describes systems and methods for video completion. Global motion parameters may be determined for a current frame that is to be stabilized. Motion vectors for edge blocks of the current frame may then be calculated. For a prospective new block beyond the current frame, candidate blocks may be generated using the calculated motion vectors and a global motion vector predicted by the global motion parameters. From the candidate blocks, a candidate block may be selected to be the new block, wherein the selected candidate block may be placed at least partially within the outer boundary of the eventual stabilized version of the current frame.

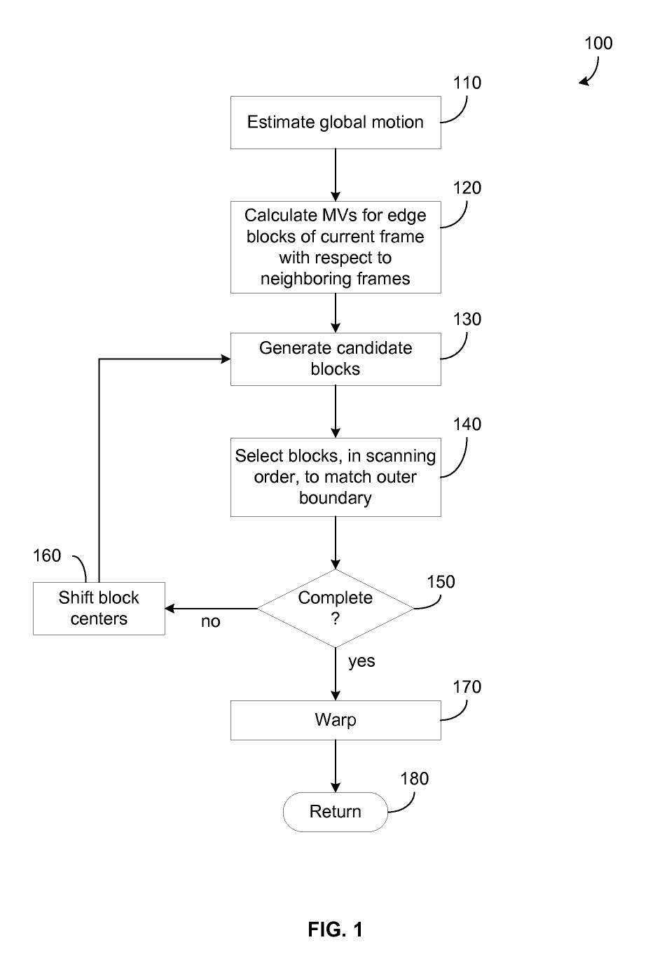

This processing is illustrated generally in FIG. 1. At 110, the global motion of the current frame (i.e., the frame being stabilized) may be determined, as modeled by global motion parameters. In an embodiment, the global motion parameters may be used to predict global motion vectors for respective points in the current frame. Methods for global motion estimation in this context are known in the art, and include the processes described by Odobez, et al. (M. Odobez, P. Bouthemy, and P. Temis, “Robust multiresolution estimation of parametric motion models,” Journal of Visual Communication and Image Representation, vol. 6, pp. 348-365, 1995) and Battiato, et al. (S. Battiato, G. Puglisi, and A. Bruna, “A robust video stabilization system by adaptive motion vectors filtering,” ICME, pp. 373-376, April 2008), for example.

At 120, motion vectors (MVs) may be calculated for blocks at the edge of the current frame, wherein the motion vectors may be calculated with respect to neighboring frames. The search for the motion vector for a given edge block may be initialized by using a global motion vector that is predicted by global motion parameters, as will be described in greater detail below. At 130, a set of candidate blocks may be generated for every prospective block that will be used for completion, starting with the prospective blocks that will border the edge of the current frame. As will be discussed below, the generation of candidate blocks may use the global motion vector and the MVs calculated at 120.

At 140, one of the candidate blocks may be chosen for each of the prospective blocks, and put in place. In an embodiment, a particular order may be followed in selecting candidate blocks to line the border of the current frame, as will be discussed below. If, after candidate blocks are selected to line the border, the completion is not yet finished as determined at 150, then another set of blocks may be created, where these new blocks may be further removed from the edge of the current frame. Relative to the first set of selected candidate blocks that are placed in the first layer adjacent to the current frame, the centers of the next set may be shifted outwards (160) from the edge of the current frame. The extent of this shift will be discussed further below. This new layer of blocks may be chosen by generating additional candidates at 130 and making further selections, as shown in the loop of FIG. 1.

After completion (as determined at 150), warping of the current frame may take place at 170 in order to create the stabilized frame. The process may conclude at 180.

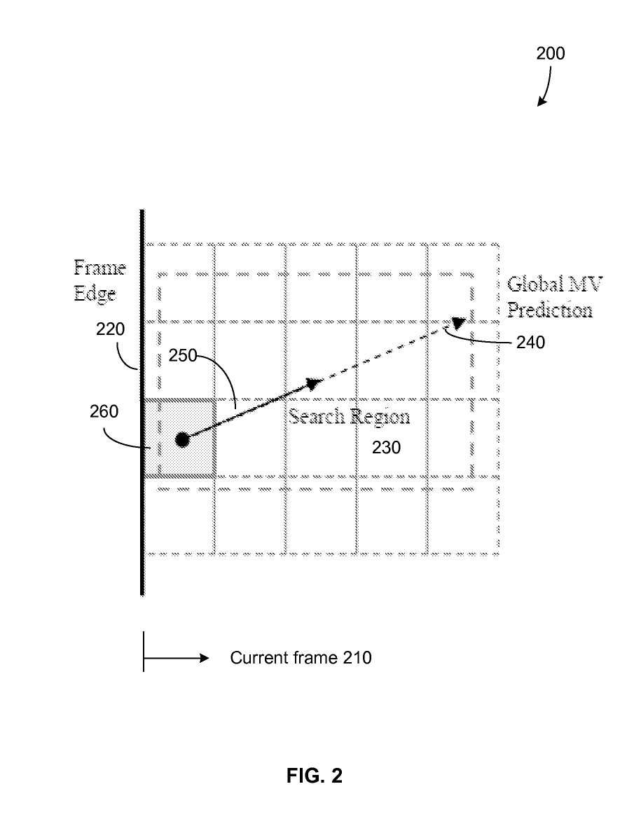

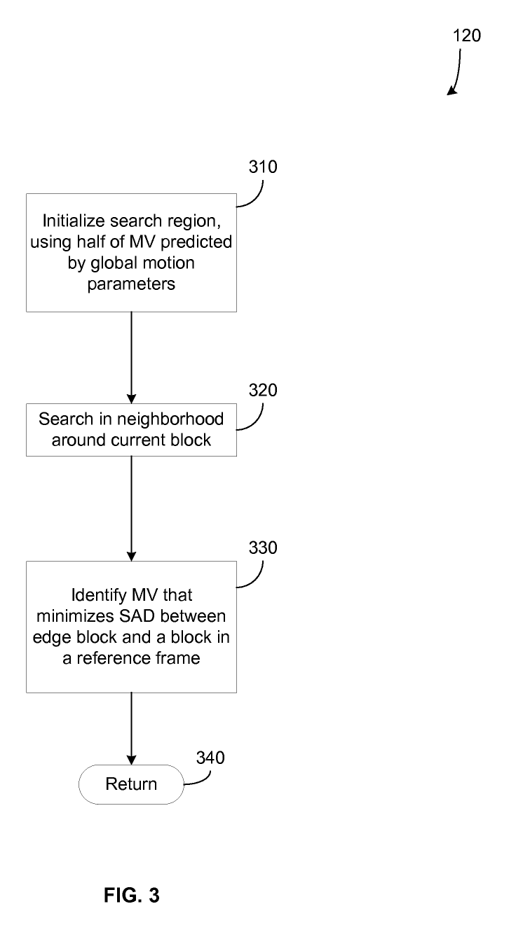

The calculation of an MV for an edge block (120 above) is shown in greater detail in FIGS. 2 and 3, according to an embodiment. As shown in FIG. 2, a current frame 210 may have a frame edge 220. For an edge block 260, a search region 230 may be defined. To initialize the search and the search region, the global motion vector 240 may be used. In particular, the initialization of the search may use one half of the global motion vector 240, shown as vector 250.

The process of calculating a MV for an edge block is illustrated in FIG. 3. At 310, the search region may be initialized. In the illustrated embodiment, this may be done using the MV that is predicted by the global motion parameters. For purposes of initializing the search, half of this MV may be used. At 320, the search may be performed in a neighborhood surrounding the edge block. At 330, an MV may be identified, where the MV may minimize the SAD between the edge block and a block in a reference frame. The process may conclude at 340. In an embodiment, the process of FIG. 3 may be repeated for as many edge blocks as necessary.

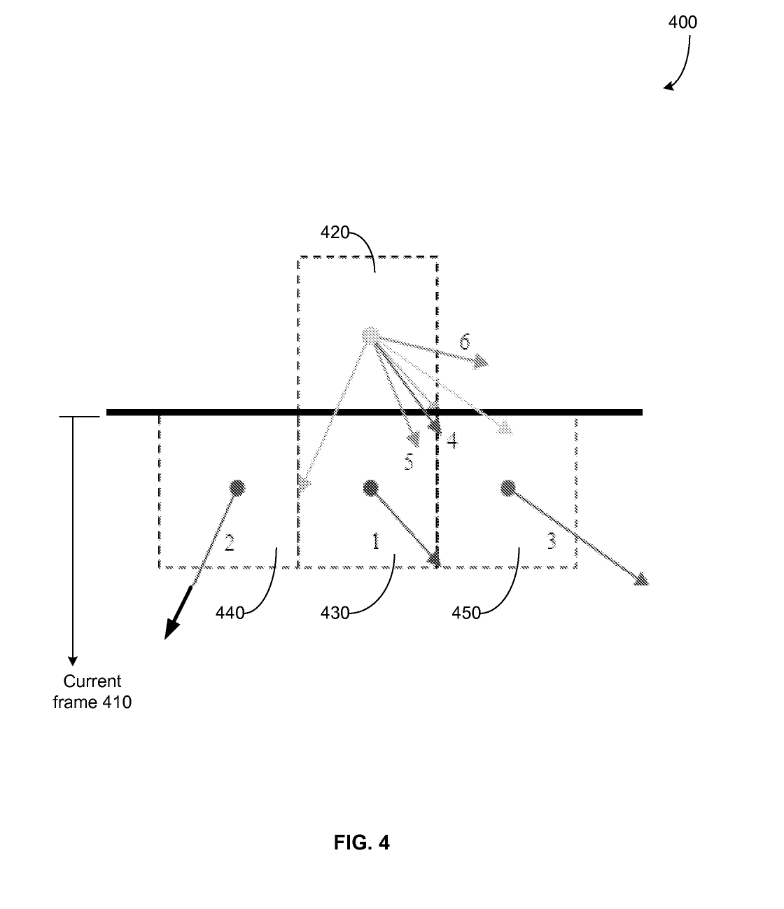

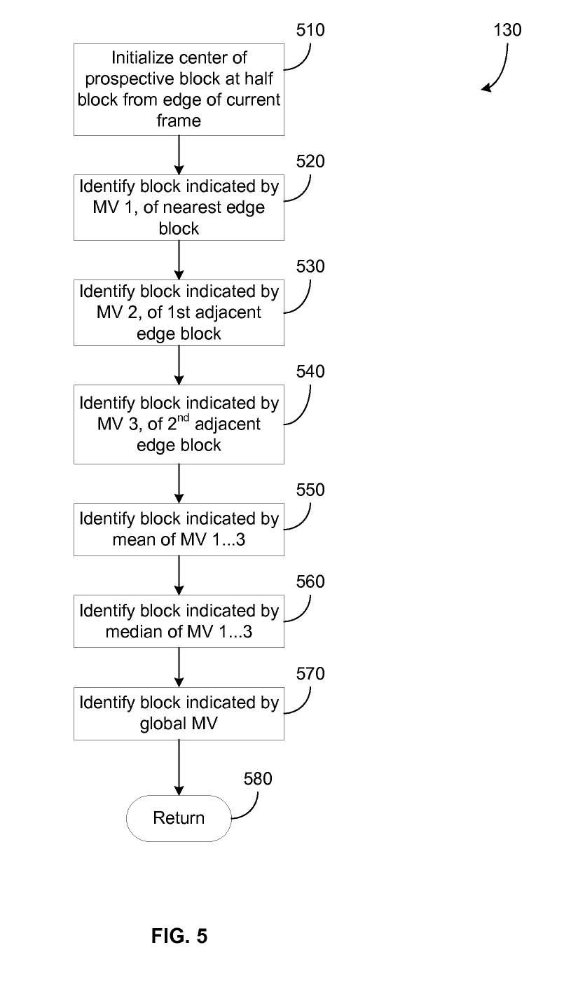

The generation of candidate blocks (130 of FIG. 1) is illustrated in greater detail in FIGS. 4 and 5, according to an embodiment. FIG. 4 illustrates the generation of six candidate blocks, where each of these candidates may represent prospective blocks to fill the space outside a current frame 410 opposite an edge block 430 in current frame 410. Each candidate block may be defined in terms of a respective motion vector. These motion vectors are labeled 1 through 6. MV 1 may be the motion vector of the edge block 430. MV 2 may be the motion vector of an edge block 440 that is adjacent to edge block 430. MV 3 may be the motion vector of an edge block 450 on the other side of edge block 430. MV 4 may be the median of MVs 1 . . . 3. MV 5 may be the mean of MVs 1 . . . 3. MV 6 may be the global MV derived above for the edge block. Each of MV 1 through MV 6 may indicate a block that is a candidate to fill the space shown as block 420 in the area to be completed outside of current frame 410.

The process of generating these candidate blocks is shown in FIG. 5, according to an embodiment. At 510, the center of a prospective block may be defined initially at a distance of one half block from the edge of the current frame. At 520, a candidate block may be identified by a motion vector of the nearest edge block in the current frame, such as block 430 in FIG. 4. At 530, another candidate block may be identified by a motion vector of a first block adjacent to the nearest edge block in the current frame. At 540, another candidate block may be identified by a motion vector of a second edge block in the current frame. At 550, another candidate block may be identified by a motion vector that is the mean of the first three motion vectors from 520 through 540 above. At 560, another candidate block may be identified by a motion vector that is the median of the first three motion vectors from 520 through 540 above. At 570, another candidate block may be identified by the global motion vector. The process may conclude at 580.

Note that a set of candidate blocks may be generated with respect to each edge block of the current frame. The sequence 510-560 may therefore be repeated, with each iteration using another edge block as its nearest block. Moreover, for each edge block, the six motion vectors determined in process 500 may be determined relative to a frame adjacent to a current frame. For each edge block, process 500 may be repeated for each frame that is neighbors the current frame, so that six motion vectors will be determined (and six candidate blocks generated) with respect to each frame adjacent to the current frame. Given two neighboring frames, for example, a total of 12 candidate blocks may be generated for each edge block. Note that neighboring frames may or may not be immediately adjacent.

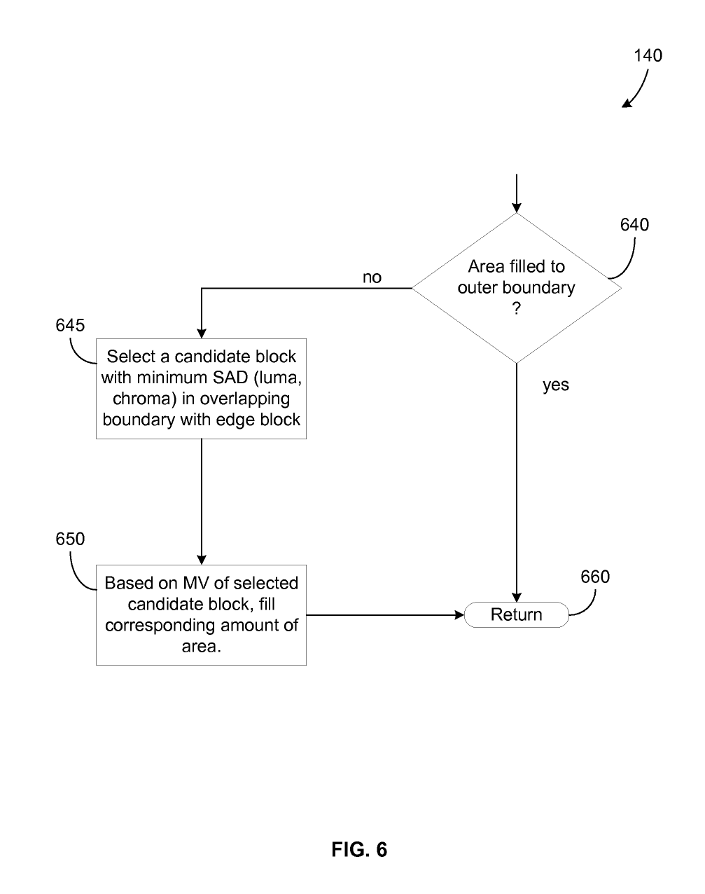

The selection of a particular block from among the candidate blocks corresponding to an edge block is illustrated in FIG. 6, according to an embodiment.

At 640, a determination may be made as to whether the area extending to the outer boundary has been filled already. If so, there may be no need to add another block or fill in additional area, the process may conclude at 660. If not, then the process may continue at 645. Here, one of the candidate blocks may be selected, where the selected block, when bordering the edge of the current frame, minimizes the SAD with respect to the chroma and luma components between overlapping boundaries of the candidate block and the nearest edge block.

At 650, the amount of area to be filled may be determined by the MV of the selected candidate block. The selected candidate block may be used to fill in a number of lines, where the number of lines may be dependent on the MV of the selected candidate block. For example, if filling an area at the top of a current frame, say that the MV of the selected candidate block has a y component of −5. In this case, the selected candidate block may be used only to fill in five lines. This can be viewed as shifting the center of the selected candidate block upward by five lines. Filling in area at the bottom, left, or right of the current frame may be treated analogously. Completion to the left or right of the current frame using a selected candidate block may be controlled by the x-coordinate of the MV of the selected candidate block, for example. The process may conclude at 660.

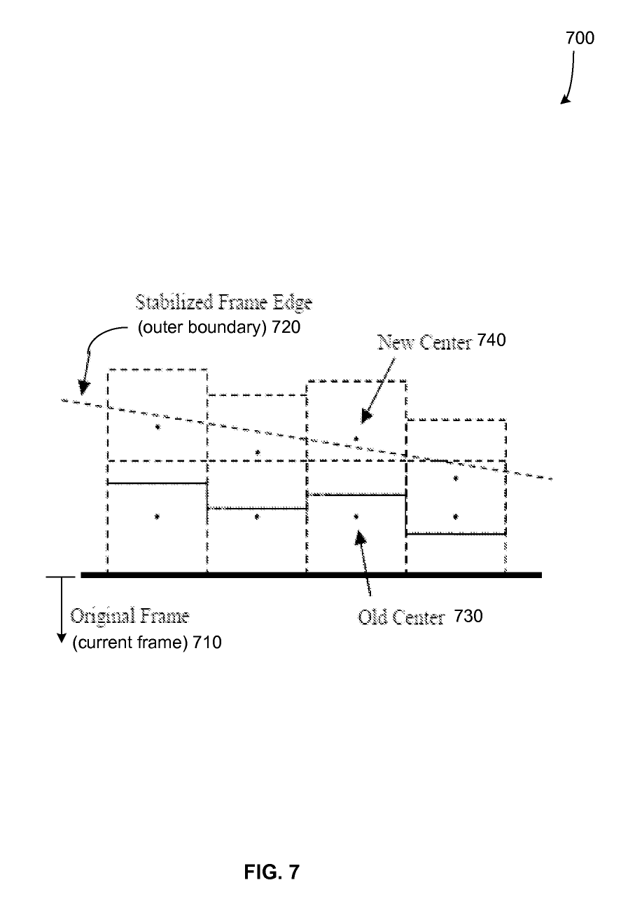

This process of filling an area to an extent that varies with the MV of the selected candidate block is illustrated in FIG. 7, according to an embodiment. This figure shows an original, i.e., current frame 710 and an outer boundary 720. The old center 730 represents the center of a block that may be placed against the original frame 710. The new center 740 may represent the location of a selected candidate block, where the position of this block may depend on the motion vector of the selected candidate block. The number of lines that are newly covered using the selected candidate block in this example may correspond to the y-coordinate of the MV of the selected candidate block in this example.

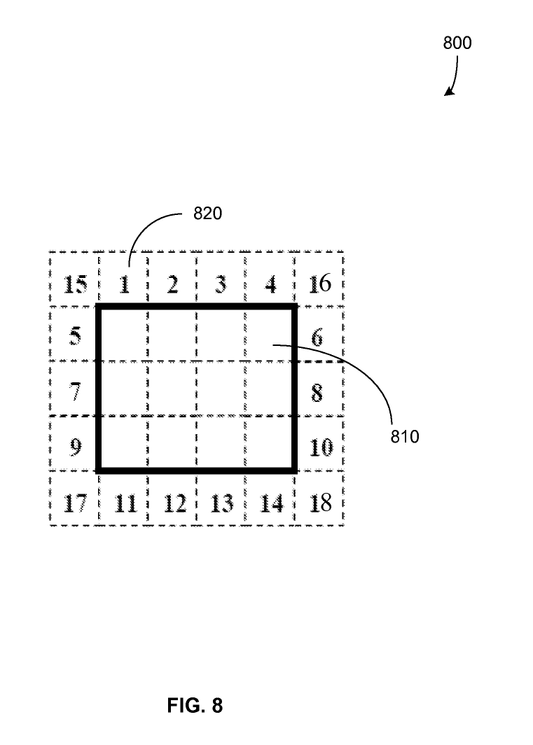

In an embodiment, there may be a need to perform 130-140 (see FIG. 1) around the complete perimeter of a current frame, such as frame 810 of FIG. 8. In this situation, the order shown in FIG. 8 may be used to fill the area to be completed. The initial layer of selected blocks is shown. The first selected block may be placed in location 1 (shown as block 820). Once this block has been selected from a set of candidates and placed in the indicated location, a block may be selected for location 2 from a set of candidates developed for that location. The process may continue for all locations around current frame 810, in the order shown. In the illustrated embodiment, the corner locations may be filled last.

If, after this initial layer is done, it is necessary to fill additional area, then the process is not yet complete (as determined at 150 of FIG. 1). In this case, another layer may be constructed in an analogous manner.

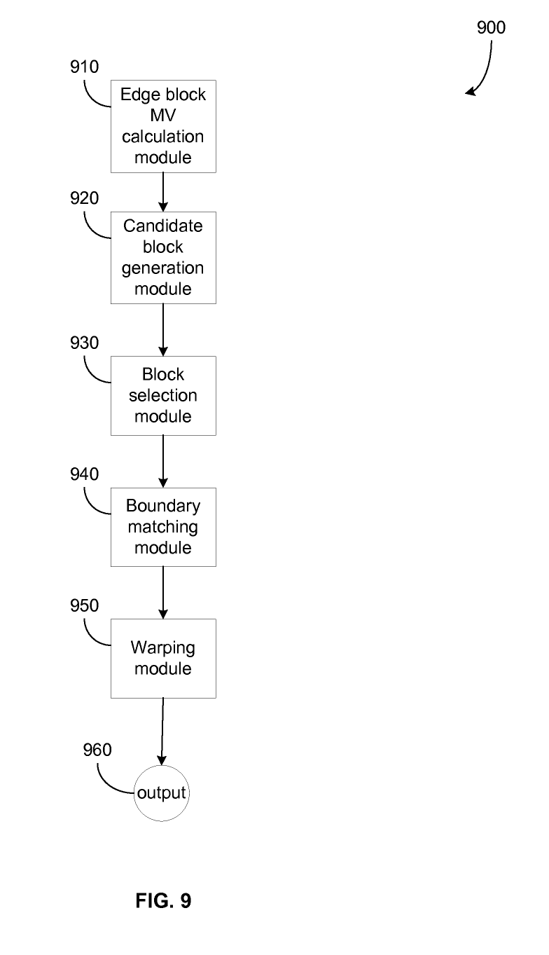

A system for performing the processing above is illustrated in FIG. 9, according to an embodiment. An edge block MV calculation module 910 calculates motion vectors for respective edge blocks of a current frame. For each edge block, a candidate block generation module 920 receives a motion vector generated by module 910 and generates a set of candidate blocks that may be used in filling an area to be completed, at a location opposite the edge block. Indicators that identify the candidate blocks may be sent to a block selection module 930, which forwards the indicators of the candidate blocks to boundary matching module 940. At boundary matching module 940, a particular candidate block may be selected (as discussed above with respect to reference 610 of FIG. 6) where the selected candidate block may be used as necessary to fill in area between the current frame and the outer boundary. As discussed above, the number of lines that are filled in using the selected candidate block may depend on the MV of the selected candidate block. As noted above, the processing may be iterative in order to build up the area that is completed. The result, the current frame plus selected candidate blocks (or portions thereof) surrounding the current frame, may then be sent to a warping module 960, which produces a stabilized frame as output 970.

The modules described above may be implemented in hardware, firmware, or software, or a combination thereof. In addition, any one or more features disclosed herein may be implemented in hardware, software, firmware, or combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, may refer to a computer program product including a computer readable medium having computer program logic stored therein to cause a computer system to perform one or more features and/or combinations of features disclosed herein.

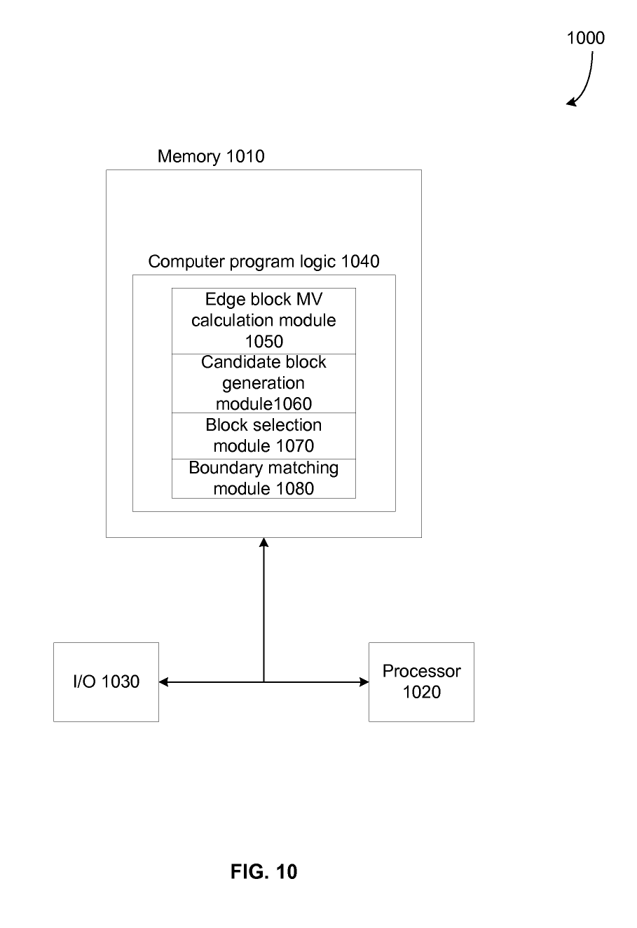

A software or firmware embodiment of the processing described above is illustrated in FIG. 10. System 1000 may include a processor 1020 and a body of memory 1010 that may include one or more computer readable media that may store computer program logic 1040. Memory 1010 may be implemented as a hard disk and drive, a removable media such as a compact disk and drive, or a read-only memory (ROM) device, for example. Processor 1020 and memory 1010 may be in communication using any of several technologies known to one of ordinary skill in the art, such as a bus. Logic contained in memory 1010 may be read and executed by processor 1020. One or more I/O ports and/or I/O devices, shown collectively as I/O 1030, may also be connected to processor 1020 and memory 1010.

Computer program logic may include modules 1050-1080, according to an embodiment. Edge block MV calculation module 1050 may be responsible for calculating an MV for each edge block of a current frame. Candidate block generation module 1060 may be responsible for generating a set of candidate blocks for a given location that needs to be completed opposite an edge block. Block selection module 1070 may be responsible for forwarding the candidate blocks to boundary matching module 1080. Boundary matching module 1080 may be responsible for using a selected candidate block in order to fill in area between the current frame and the outer boundary, where the extent to which the area is covered may depend on the MV of the selected candidate block.

### CONCLUSION

Methods and systems are disclosed herein with the aid of functional building blocks, such as those listed above, describing the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
determining global motion parameters for a current frame that is to be stabilized;
calculating a motion vector for each of a plurality of edge blocks of the current frame, wherein each edge block motion vector is calculated with respect to neighboring frames;
for a prospective new block beyond the current frame, generating a plurality of candidate blocks using the calculated edge block motion vectors and a global motion vector predicted by the global motion parameters; and
selecting, from the plurality of candidate blocks, a candidate block to be the new block, wherein the selected candidate block is placed at least partially within the outer boundary of a stabilized version of the current frame.

2. The method of claim 1, further comprising:
warping the current frame to create the stabilized version of the current frame.

3. The method of claim 1, wherein said calculating of a motion vector for each edge block comprises:
initializing a search region for the edge block's motion vector, said initializing using half of the global motion vector;
searching in a neighborhood around the edge block; and
identifying a motion vector for the current edge block, wherein the identified motion vector minimizes a sum of absolute differences (SAD) between the edge block and a reference block.

4. The method of claim 1, wherein said generating of the plurality of candidate blocks comprises:
initializing the center of the prospective new block a half block away from an edge block at an edge of the current frame; and
identifying, starting at the center of the prospective new block,
a. a block indicated by the motion vector of the edge block;
b. a block indicated by a motion vector of a first edge block adjacent to the edge block;
c. a block indicated by a motion vector of a second edge block adjacent to the edge block;
d. a block indicated by a motion vector that is a mean of the motion vectors of a. through c.;
e. a block indicated by a motion vector that is a median of the motion vectors of a. through c.; and
f. a block indicated by the global motion vector.

5. The method of claim 4, wherein the plurality of candidate blocks comprises a plurality of sets of blocks a. through f., where the plurality of sets is determined with respect to a respective plurality of frames neighboring the current frame.

6. The method of claim 1, wherein said selecting comprises:
when the selected candidate block is placed, using the selected candidate block to fill in area between the current frame and the outer boundary to an extent dependent on an x or y coordinate of a motion vector of the selected candidate block.

7. The method of claim 6, wherein said selecting further comprises:
selecting the candidate block that yields the minimal sum of absolute differences (SAD), with respect to luma and chroma components, between overlapping boundaries of the selected candidate block and the edge block.

8. A system, comprising:
a processor; and
a memory in communication with said processor, wherein the memory stores a plurality of processing instructions configured to direct said processor to
determine global motion parameters for a current frame that is to be stabilized;
calculate a motion vector for each of a plurality of edge blocks of the current frame, wherein each edge block motion vector is calculated with respect to neighboring frames;
for a prospective new block beyond the current frame, generate a plurality of candidate blocks using the calculated edge block motion vectors and a global motion vector predicted by the global motion parameters;
select, from the plurality of candidate blocks, a candidate block to be the new block, wherein the selected candidate block is placed at least partially within the outer boundary of a stabilized version of the current frame.

9. The system of claim 8, wherein said memory further stores processing instructions configured to direct said processor to warp the current frame to create the stabilized version of the current frame.

10. The system of claim 8, wherein said processing instructions for directing said processor to calculate a motion vector for each edge block of the current frame comprises instructions configured to direct said processor to
initialize a search region for a motion vector of the edge block, said initializing using half of the global motion vector;
search in a neighborhood around the edge block; and
identify a motion vector for the edge block, wherein the identified motion vector minimizes a sum of absolute differences (SAD) between the edge block and a reference block.

11. The system of claim 8, wherein said processing instructions configured to direct said processor to generate of a plurality of candidate blocks comprises instructions configured to direct said processor to
initialize the center of the prospective new block a half block away from an edge block at an edge of the current frame; and
identify, starting at the center of the prospective new block,
a. a block indicated by the motion vector of the edge block;
b. a block indicated by a motion vector of a first edge block adjacent to the edge block;
c. a block indicated by a motion vector of a second edge block adjacent to the edge block;
d. a block indicated by a motion vector that is a mean of the motion vectors of a. through c.;
e. a block indicated by a motion vector that is a median of the motion vectors of a. through c.; and
f. a block indicated by the global motion vector.

12. The system of claim 11, wherein the plurality of candidate blocks comprises a plurality of sets of blocks a. through f., where the plurality of sets is determined with respect to a respective plurality of frames neighboring the current frame.

13. The system of claim 8, wherein said processing instructions configured to direct said processor to select, from the plurality of candidate blocks, a candidate block to be the new block comprises instructions configured to direct said processor to
when the selected candidate block is placed, using the selected candidate block to fill in area between the current frame and the outer boundary to an extent dependent on the x or y coordinate of a motion vector of the selected candidate block.

14. The system of claim 13, wherein said processing instructions for directing said processor to select, from the plurality of candidate blocks, a candidate block to be the new block further comprise instructions configured to direct said processor to
select the candidate block that yields the minimal sum of absolute differences (SAD), with respect to luma and chroma components, between overlapping boundaries of the selected candidate block and the current edge block.

15. A system, comprising:
an edge block motion vector calculation module, configured to calculate a motion vector for each of a plurality of edge blocks of a current frame, wherein each edge block motion vector is calculated with respect to neighboring frames;
a candidate block generation module in communication with said edge block motion vector calculation module and configured to receive said edge block motion vectors from said edge block motion vector calculation module and to generate a plurality of candidate blocks using the calculated edge block motion vectors and a global motion vector predicted by global motion parameters for a prospective new block beyond said current frame;
a block selection module in communication with said candidate block generation module and configured to receive indicators of said candidate blocks from said candidate block generation module and to select a candidate block; and
a boundary matching module in communication with said block selection module and configured to receive an indication of said selected candidate block from said block selection module and to place said selected candidate block at least partially inside an outer boundary of a stabilized version of said current frame.

16. The system of claim 15, wherein said edge block motion vector calculation module is further configured to initialize a search region for a motion vector of each edge block, said initializing using half of a global motion vector;
search in a neighborhood around the edge block; and
identify a motion vector for the edge block, wherein the identified motion vector minimizes a sum of absolute differences (SAD) between the edge block and a reference block.

17. The system of claim 15, wherein said candidate block generation module is further configured to initialize the center of the prospective new block a half block away from an edge block at an edge of the current frame; and
identify, starting at the center of the prospective new block,
a. a block indicated by the motion vector of the edge block;
b. a block indicated by a motion vector of a first edge block adjacent to the edge block;
c. a block indicated by a motion vector of a second edge block adjacent to the edge block;
d. a block indicated by a motion vector that is a mean of the motion vectors of a. through c.;
e. a block indicated by a motion vector that is a median of the motion vectors of a. through c.; and
f. a block indicated by a global motion vector for the edge block.

18. The system of claim 17, wherein the plurality of candidate blocks comprises a plurality of sets of blocks a. through f., where the plurality of sets is determined with respect to a respective plurality of frames neighboring the current frame.

19. The system of claim 15, wherein said block choice module is further configured to
select the candidate block that yields the minimal sum of absolute differences (SAD), with respect to luma and chroma components, between overlapping boundaries of the selected candidate block and the current edge block.

20. The system of claim 15, wherein said boundary matching module is further configured to,
when the selected candidate block is placed, use the selected candidate block to fill in area between the current frame and the outer boundary to an extent dependent on an x or y coordinate of a motion vector of the selected candidate block.

21. A computer program product including a computer readable medium having computer program logic stored therein, the computer program logic including:
logic to cause a processor to determine global motion parameters for a current frame that is to be stabilized;
logic to cause a processor to calculate a motion vector for each of a plurality of edge blocks of the current frame, wherein the motion vectors are calculated with respect to neighboring frames;
logic to cause a processor to generate, for a prospective new block beyond the current frame, a plurality of candidate blocks using the calculated edge block motion vectors and a global motion vector predicted by the global motion parameters; and
logic to cause a processor to select, from the plurality of candidate blocks, a candidate block to be the new block, wherein the selected candidate block is placed at least partially within the outer boundary of a stabilized version of the current frame.

22. The computer program product of claim 21, wherein said logic to cause the processor to calculate a motion vector for each edge block of the current frame comprises:
logic to cause the processor to initialize a search region for the edge block motion vector, said initializing using half of the global motion vector;
logic to cause the processor to search in a neighborhood around the edge block; and
logic to cause the processor to identify the motion vector for the edge block, wherein the identified motion vector minimizes a sum of absolute differences (SAD) between the edge block and a reference block.

23. The computer program product of claim 21, wherein said logic to cause the processor to generate a plurality of candidate blocks using the global motion vector and the calculated motion vector comprises:
logic to cause the processor to initialize the center of the prospective new block a half block away from an edge of the current frame; and
logic to cause the processor to identify, starting at the center of the prospective new block,
a. a block indicated by the motion vector of the edge block;
b. a block indicated by a motion vector of a first edge block adjacent to the edge block;
c. a block indicated by a motion vector of a second edge block adjacent to the edge block;
d. a block indicated by a motion vector that is a mean of the motion vectors of a. through c.;
e. a block indicated by a motion vector that is a median of the motion vectors of a. through c.; and
f. a block indicated by the global motion vector.

24. The computer program product of claim 23, wherein the plurality of candidate blocks comprises a plurality of sets of blocks a. through f., where the plurality of sets is determined with respect to a respective plurality of frames neighboring the current frame.

25. The computer program product of claim 21, further comprising:
logic to cause the processor, when the selected candidate block is placed, to use the selected candidate block to fill in area between the current frame and the outer boundary to an extent dependent on an x or y coordinate of a motion vector of the selected candidate block.

26. The computer program product of claim 21, wherein said logic to cause a processor to choose a candidate block to be the new block further comprises:
logic to cause the processor to select the candidate block that yields the minimal sum of absolute differences (SAD), with respect to luma and chroma components, between overlapping boundaries of the selected candidate block and the edge block.
